(19) United States
(12) Patent Application Publication
(10) Pub. No.: US 2025/0322788 A1
(43) Pub. Date: Oct. 16, 2025

(54) ORGANIC LIGHT EMITTING DIODE DISPLAY ADJUSTABLE POSITIVE VOLTAGE POWER SUPPLY

(71) Applicant: DELL PRODUCTS L.P., Round Rock, TX (US)

(72) Inventors: Daehyun Kim, Singapore (SG); Seungjoo Choi, Singapore (SG); Guentaek Oh, Singapore (SG)

(21) Appl. No.: 18/631,864

(22) Filed: Apr. 10, 2024

(51) Int. Cl. G09G 3/3208

(52) U.S. Cl. CPC G09G 3/3208; G09G 2330/021; G09G 2354/00

(57) ABSTRACT

An information handling system determines a brightness level associated with a brightness mode of a display. The system determines an electroluminescence voltage based on the brightness level associated with the brightness mode of the display, and supplies the electroluminescence voltage to a display panel.

### FIELD OF THE DISCLOSURE

The present disclosure generally relates to information handling systems, and more particularly relates to organic light emitting diode (OLED) display adjustable positive voltage power supply.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system determines a brightness level associated with a brightness mode of a display. The system determines an electroluminescence voltage based on the brightness level associated with the brightness mode of the display, and supplies the electroluminescence voltage to a display panel.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram of a display with an adjustable positive voltage power supply, according to an embodiment of the present disclosure;

FIG. 3 is a flowchart of a method for a display with an adjustable positive voltage power supply, according to an embodiment of the present disclosure;

FIG. 4 is a table that shows a mapping of brightness modes to brightness levels, according to an embodiment of the present disclosure, and

FIG. 5 is a table that shows a mapping of brightness levels to electroluminescence voltage values, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

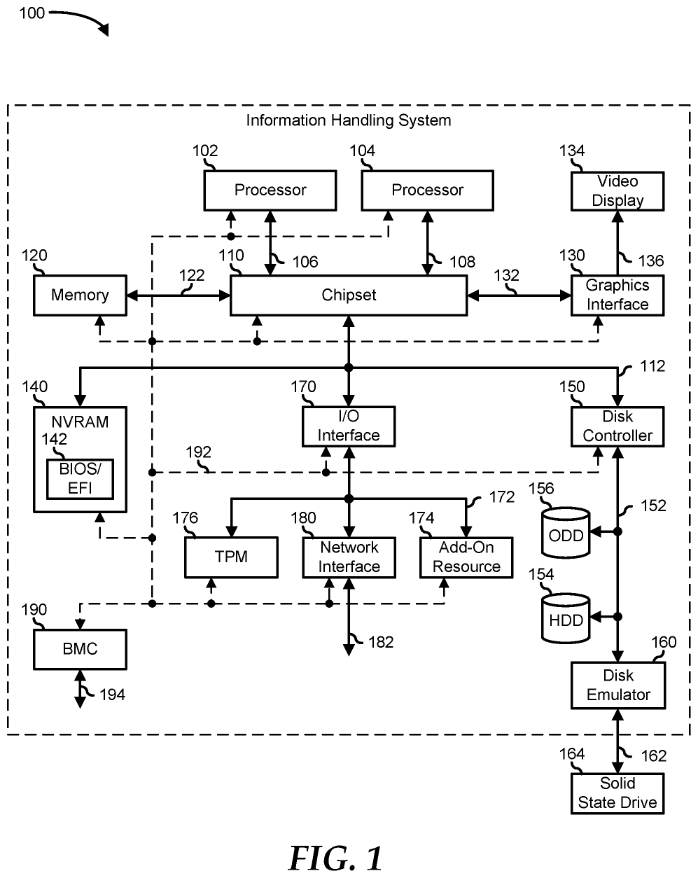

FIG. 1 illustrates an embodiment of an information handling system 100 including processors 102 and 104, a chipset 110, a memory 120, a graphics adapter 130 connected to a video display 134, a non-volatile RAM (NVRAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NVRAM 140, disk controller 150, and I/O interface 170 are connected to chipset 110 via an I/O channel 112. An example of I/O channel 112 includes one or more point-to-point PCIe links between chipset 110 and each of NVRAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a Universal Serial Bus (USB), another interface, or a combination thereof. NVRAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Information can be sent from the management system to BMC 190 and the information can be stored in a RAM or NVRAM associated with the BMC. Information stored in the RAM may be lost after power-down of the power plane for BMC 190, while information stored in the NVRAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, an I²C bus and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Organic light-emitting diode (OLED) displays typically have higher power consumption than a liquid-crystal display device. An OLED display typically uses an electroluminescence voltage (ELVDD) as its a main power source. The ELVDD, which is also referred to as an electroluminescent positive driving voltage is one of three outputs of a power management integrated circuit (PMIC). The ELVDD can be used to determine a maximum driving current at an emission layer area of the OLED display. Thus, the ELVDD may be used to determine a power consumption of the OLED display.

A typical OLED display has several brightness modes, such as standard dynamic ratio (SDR) and high dynamic ratio (HDR). The HDR brightness mode has a wider range of brightness and colors than SDR. For example, SDR has a limited brightness range, typically around 100 to 300 nits while HDR has a wider range that can exceed 1000 nits. Generally a single ELVDD, which is the ELVDD for the HDR mode with a brightness value of 1000 nits, is applied to the different brightness levels. Because of this, OLED displays generally have high power consumption even at lower brightness levels. Thus to improve the power consumption of the OLED display among other concerns, the present disclosure provides a system and method for a variable ELVDD based on the display's brightness mode and/or brightness level.

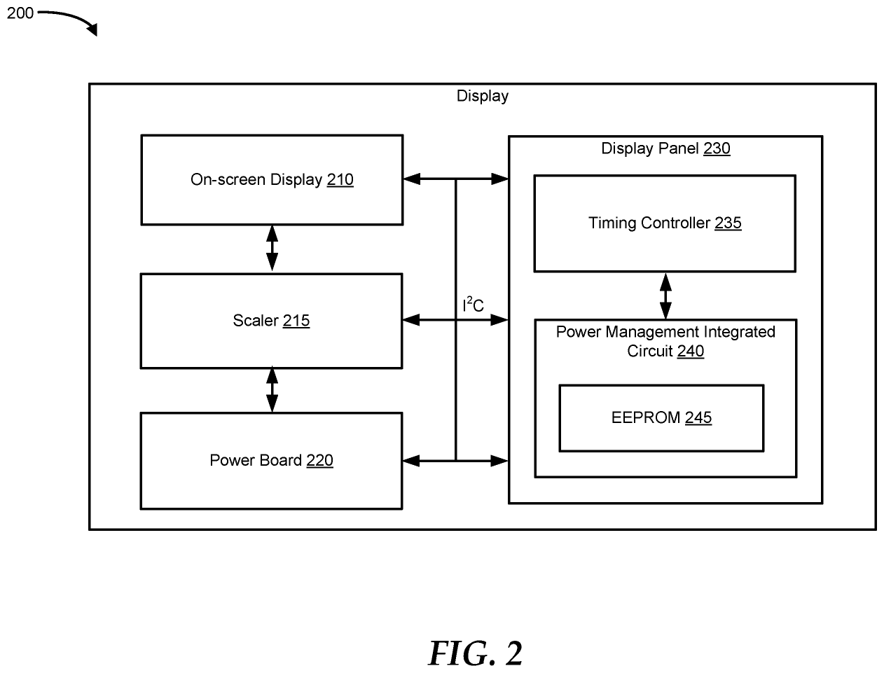

FIG. 2 shows a display 200 configured with adjustable ELVDD. Display 200 includes an on-screen display 210, a scaler 215, a power board 220, and a display panel 230. Display panel 230 includes a timing controller 235 and a PMIC 240 that further includes an electrically erasable programmable read-only memory (EEPROM) 245. Display panel 230 may be communicatively coupled to on-screen display 210, scaler 215, and power board 220. For example, scaler 215 may be communicatively coupled with display panel 230 via an interface, such as an I²C interface, an SPI, or the like. However, any variety of connections between display panel 230 with on-screen display 210, scaler 215, and power board 220 are envisioned as falling within the scope of the present disclosure. In addition, connections between components may be omitted for descriptive clarity.

Display 200 may be a display device for displaying visual information, such as images and/or videos at display panel 230. For example, some information handling systems such as desktop computers, laptop/notebook computers, tablet computers, mobile phones, televisions, and/or other computing systems known in the art can use display 200. In one particular example, display 200 may be a display device associated with information handling system 100 of FIG. 1. In one embodiment, display 200 may be an OLED display device, a quantum-dot (QD) OLED display device, a quantum dot nanorod emitting diode (QNED) display device, a white OLED (WOLED) display device, or similar.

On-screen display 210 may be an interface of an on-screen display software that shows a menu that can be used to select a brightness mode and/or a brightness level. For example, a user can select between various brightness modes including SDR and HDR brightness modes. The choices may include other HDR brightness modes according to their nit values. For example, HDR brightness modes include an HDR 400 and HDR 1000 among others, wherein HDR 400 has a maximum brightness level of 400 nits while HDR 1000 has a maximum brightness level of 1000 nits. The user can also select various brightness levels associated with the SDR brightness mode. For example, the user can select among 100%, 75%, and 50% brightness levels, among others. However, a default brightness mode and/or brightness level may be selected during a boot process.

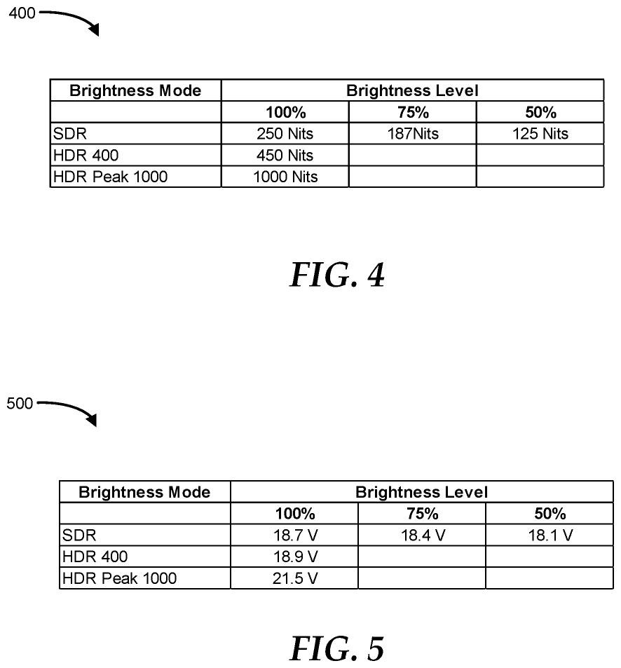

Scaler 215 may be configured to receive a notification event associated with a selection of the brightness mode and/or the brightness level of display 200. For example, scaler 215 may receive a change notification event associated with a selection or change in the brightness mode and/or the brightness level of display 200. Scaler 215 may be configured to detect the brightness mode selected based on the notification event. If the brightness mode selected is SDR brightness mode, then scaler 215 may also detect a selected brightness level. In one example, the default brightness level for the SDR brightness mode is 75%. Scaler 215 may determine a maximum brightness level value in nits associated with the brightness mode based on a lookup table, such as a table 400 of FIG. 4. In a particular example, if the brightness mode is SDR and the brightness level is 50%, then the value of the brightness level is 125 nits. Accordingly, scaler 215 may set the maximum brightness level value of display 200 to 125 nits. Scaler 215 may transmit the maximum brightness level value to timing controller 235 via an I²C interface.

Timing controller 235 may be a single circuit device or a printed circuit board including one or more integrated circuit devices and other devices as needed or desired. Timing controller 235 may be configured to receive information associated with the maximum brightness level from scaler 215 via the I²C interface. Timing controller 235 may determine a maximum ELVDD value associated with the maximum brightness level value based on a lookup table, such as a table 500 of FIG. 5. Timing controller 235 may transmit the maximum ELVDD value to PMIC 240. Timing controller 235 may also store the maximum ELVDD value in EEPROM 245.

PMIC 240 may be configured as a source of power for display panel 230. PMIC 240 may be configured to adjust its ELVDD output based on the maximum ELVDD value, wherein the ELVDD output is used as a driving voltage to supply power to display panel 230. The adjustment may be based on an ELVDD maximum value that is stored in EEPROM 245. Power board 220 may be configured to accept external power, such as from an alternating current (AC) outlet and convert the AC power to a direct current (DC) power suitable for use by display 200. In particular, power board 220 may be configured to provide DC power as an input power to PMIC 240. By adjusting the ELVDD output, power consumption of display 200 may be reduced compared to a typical power consumption of a conventional OLED display without compromising the brightness levels.

Those of ordinary skill in the art will appreciate that the configuration, hardware, and/or software components of display 200 depicted in FIG. 2 may vary. For example, the illustrative components within display 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

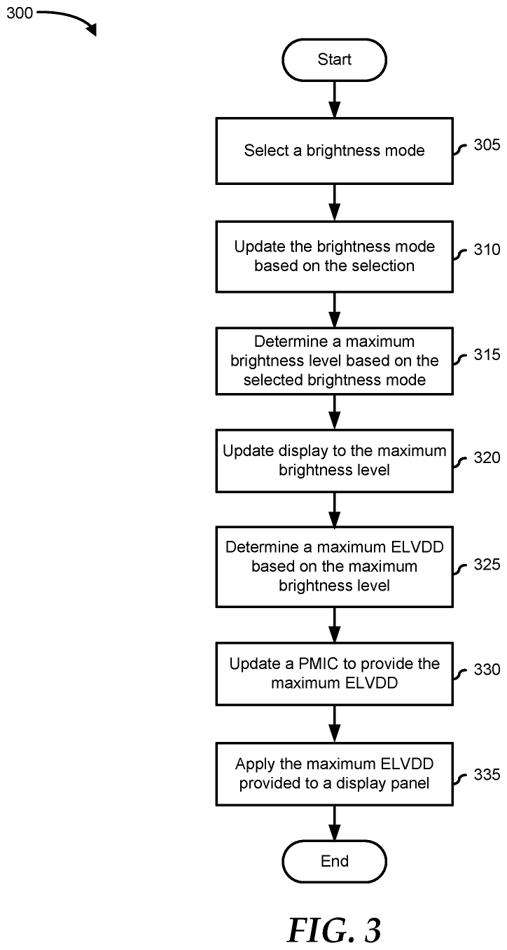

FIG. 3 shows a flowchart of a method 300 for an adjustable ELVDD. Method 300 may be performed by any suitable component of display 200 including, but not limited to on-screen display 210, scaler 215, power board 220, and display panel 230 including timing controller 235 and PMIC 240 of FIG. 2. While embodiments of the present disclosure are described in terms of the components of display 200 of FIG. 2, it should be recognized that other components may be utilized to perform the described method. One of skill in the art will appreciate that this sequence diagram explains a typical example, which can be extended to applications or services in practice.

Method 300 typically starts at block 305 where a brightness mode may be selected, such as by a user using an on-screen display 210 menu. If the user does not select a brightness mode, then a default brightness mode may be selected. In one example, an application may automatically change the display's brightness mode and/or brightness level depending on what content is being displayed. The method proceeds to block 310 where an on-screen display software associated with on-screen-display 210 may update a brightness mode setting of display 200 based on the selected brightness mode. The method proceeds to block 315 where scaler 215 may determine a maximum brightness level value in nits based on the selected brightness mode. In one embodiment, scaler 215 may use a lookup table to determine the brightness level, such as depicted in table 400 of FIG. 4. For example, HDR 1000 brightness mode may have a maximum brightness level value of 1000 nits.

The method proceeds to block 320 where scaler 215 may update the brightness level of display 200 based on the maximum brightness level determined in block 315. The brightness level may be set at or less than the maximum brightness level value in nits. The method proceeds to block 325 where timing controller 235 may determine a maximum ELVDD value of PMIC 240 based on the maximum brightness value in nits. In one embodiment, timing controller 235 may use a lookup table such as table 500 of FIG. 5. Accordingly, at block 330, timing controller 235 may provide PMIC 240 with the maximum ELVDD output. For example, timing controller 235 may store the maximum ELVDD value in EEPROM 245. At block 335, PMIC 240 may provide an ELVDD driving voltage that is less than or equal to the maximum ELVDD value. The ELVDD driving voltage may be applied to display panel 230. Afterwards, the method ends.

FIG. 4 shows table 400 which is a lookup table that shows a mapping of brightness modes to brightness levels. Each brightness level is mapped to a maximum brightness level value in nits. For example, the maximum brightness value in nits of SDR brightness mode at 100% brightness level is 275 nits. FIG. 5 shows table 500 which is a lookup table that shows a mapping of brightness level values to maximum ELVDD values. Each brightness level value may be mapped to a maximum ELVDD value. The tables 400 and 500 shown are examples for illustration and do not limit the present disclosure. In addition, one of skill in the art will understand that the mapping may be stored in a different data structure other than the lookup tables without deviating from the principles of the present disclosure.

Although FIG. 3 shows example blocks of method 300 in some implementations, method 300 may include additional blocks, fewer blocks, different blocks, or differently arranged blocks than those depicted in FIG. 3. Those skilled in the art will understand that the principles presented herein may be implemented in any suitably arranged processing system. Additionally, or alternatively, two or more of the blocks of method 300 may be performed in parallel. For example, blocks 320 and 325 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

1. A method comprising:
determining, by a scaler, a brightness level associated with a brightness mode of a display;
determining, by a timing controller, a maximum electroluminescence voltage based on the brightness level associated with the brightness mode of the display; and
supplying an electroluminescence voltage that is less than or equal to the maximum electroluminescence voltage to a display panel.

2. The method of claim 1, wherein the brightness mode setting is mapped to a maximum brightness level value.

3. The method of claim 2, wherein the brightness level is equal to or less than the maximum brightness level value.

4. The method of claim 1, wherein the brightness mode setting is selected by a user.

5. The method of claim 2, wherein the maximum brightness level value is mapped to the maximum electroluminescence voltage.

6. The method of claim 5, wherein the electroluminescence voltage that is less than or equal to the maximum electroluminescence voltage is supplied by a power management integrated circuit.

7. The method of claim 6, in response to detecting a change in the brightness mode setting, adjusting the electroluminescence voltage supplied by the power management integrated circuit.

8. An information handling system, comprising:
a processor; and
a memory storing instructions that when executed cause the processor to perform operations including:
determining, by a scaler, a brightness level associated with a brightness mode of a display of the information handling system;
determining, by a timing controller, a maximum electroluminescence voltage based on the brightness level associated with the brightness mode of the display; and
supplying an electroluminescence voltage that is less than or equal to the maximum electroluminescence voltage to a display panel.

9. The information handling system of claim 8, wherein the brightness mode setting is mapped to a maximum brightness level value.

10. The information handling system of claim 9, wherein the brightness level is equal to or less than the maximum brightness level value.

11. The information handling system of claim 8, wherein the brightness mode setting is selected by a user.

12. The information handling system of claim 9, wherein the maximum brightness level value is mapped to the maximum electroluminescence voltage.

13. The information handling system of claim 12, wherein the maximum electroluminescence voltage is supplied by a power management integrated circuit.

14. The information handling system of claim 13, wherein the operations further comprise in response to detecting a change in the brightness mode setting, adjusting the electroluminescence voltage supplied by the power management integrated circuit.

15. A non-transitory computer-readable medium to store instructions that are executable to perform operations comprising:
determining, by a scaler, a brightness level associated with a brightness mode of a display;
determining, by a timing controller, a maximum electroluminescence voltage based on the brightness level associated with the brightness mode of the display; and
supplying an electroluminescence voltage to a display panel.

16. The non-transitory computer-readable medium of claim 15, wherein the brightness mode setting is mapped to a maximum brightness level value.

17. The non-transitory computer-readable medium of claim 16, wherein the brightness level is equal to or less than the maximum brightness level value.

18. The non-transitory computer-readable medium of claim 16, wherein the maximum brightness level value is mapped to the maximum electroluminescence voltage.

19. The non-transitory computer-readable medium of claim 18, wherein the maximum electroluminescence voltage is supplied by a power management integrated circuit.

20. The non-transitory computer-readable medium of claim 15, wherein the brightness mode setting is selected by a user.
